(19) United States
(12) Patent Application Publication
(10) Pub. No.: US 2019/0238400 A1
(43) Pub. Date: Aug. 1, 2019

(54) NETWORK ELEMENT OPERATIONAL STATUS RANKING

(71) Applicant: CA, Inc., New York, NY (US)

(72) Inventors: Yang Yang, Newton, MA (US); Zubing Robin Qin, Southborough, MA (US); Fei Gu, Newton, MA (US)

(21) Appl. No.: 15/885,697

(22) Filed: Jan. 31, 2018

(51) Int. Cl. H04L 12/24; H04L 12/26

(52) U.S. Cl. CPC H04L 41/0686; H04L 43/045; H04L 41/16; H04L 43/0817

(57) ABSTRACT

Techniques and systems are disclosed for generating and implementing operational status classification extensions to determine multivariate rankings of network elements. A management system includes components that poll network elements to collect operational information such as performance metrics for operationally associated network elements. In response to detecting an operational event based on the operational information, the system includes components for generating training data and processing the training data to generate operational status classifier components.

### BACKGROUND

The disclosure generally relates to the field of data processing, and more particularly to evaluating and otherwise processing network element operation information.

Large scale computer networks frequently comprise diverse and distributed processing, storage, and connectivity devices and components. The primary structures of a computer system and/or data network are the nodes and the connection media. The nodes include connectivity infrastructure nodes as well as the end nodes. The connectivity infrastructure nodes include network nodes such as switches and routers and other types of intermediary nodes that may perform processing tasks unrelated to network traffic management. The end nodes typically comprise processing platforms having network interfaces for sending and receiving network traffic and processing components for hosting application programs. The diversity of devices and components as well as the sheer number of components that support data processing and transfer pose substantial challenges to the ability of network management systems to accurately determine which particular devices and components may be subject to and/or potentially responsible for a network failure.

### BRIEF DESCRIPTION OF THE DRAWINGS

Embodiments of the disclosure may be better understood by referencing the accompanying drawings.

FIG. 1 is a block diagram depicting subsystems, devices, and other hardware and software components for determining and displaying operational status of network elements in accordance with some embodiments;

FIG. 2A is block diagram illustrating subsystems, devices, and other hardware and software components within a system for collecting and processing network element operational metric information to configure an operational status classification extension in accordance with some embodiments;

FIG. 2B depicts a conceptual representation of a k-NN map generated by an event classifier based on event classification trainer input in accordance with some embodiments;

FIG. 2C depicts a conceptual representation of a k-NN map generated by an operational status classifier based on operational status classification trainer input accordance with some embodiments;

FIG. 3 is a flow diagram illustrating operations and functions for determining and displaying network element operational status in accordance with some embodiments;

FIG. 4 is a flow diagram depicting operations and functions for processing network element operation information to generate an operational status classification extension in accordance with some embodiments; and

FIG. 5 is a block diagram depicting an example computer system that may be utilized to determine network element operational status in accordance with some embodiments.

### DESCRIPTION

The description that follows includes example systems, methods, techniques, and program flows that embody aspects of the disclosure. However, it is understood that this disclosure may be practiced without these specific details. In other instances, well-known instruction instances, protocols, structures and techniques have not been shown in detail in order not to obfuscate the description.

Introduction

Monitoring systems of network components (networks) frequently includes collecting and analyzing operational information such as performance metrics for hardware and software components such as servers. The collected operational information may be used by a management client to determine real-time operating conditions in the network. The operating conditions may be determined from raw performance metrics and/or by processing the performance metrics to generate operational analytics. The management client can be configured to compare collected operational information with pre-specified threshold operational values to detect specified “events.” In other instances, the management client may collect operational information that temporally coincides with a detected event to determine which components have been most affected by and/or caused the event.

The vast number and variety of components in many networks necessitates means for prioritizing event handling so that monitoring system resources are optimally allocated. For example, the operational metrics for a number of network systems, sub-systems, devices, and components (collectively referred to herein as network elements) may indicate the occurrence of an event such as a network connection failure or server response failure within a network. Metrics such as processor or memory consumption may be cross-compared to determine a fault ranking among the network elements.

Overview

The disclosed methods and systems include features for determining the relative operational status of multiple network elements at a given operational instance. In some embodiments, a management system includes components that poll network elements to collect operational information such as performance metrics for operationally associated network elements. In response to detecting an operational event based on the operational information, the system includes components for generating training data and processing the training data to generate operational status (OS) classifier components. As described with respect to the figures, the collected performance metrics and/or other operational information are processed by a series of training data generators and corresponding supervised trainer components. At least one of the training data generators receives operational instance records that each contain multiple network element records. Each of the network element records comprises multiple operational metric fields associated with a network element identifier (ID) field.

An OS training data generator incudes supervised event trainer and event classifier components for generating OS training data. In some embodiments, the OS training data comprises multiple event instance records. Each of the event instance records corresponds to and includes the information in a respective one of the operational instance records associated with an operational event classification (e.g., server_1 response error). The operational event classification is determined by an event classifier component that is generated by an event classification trainer based on network specific event metric patterns. The event instance records are used as training data input to an OS classification trainer that generates OS pattern recognition code. The system further generates OS classification extensions that include the OS pattern recognition code. In response to a network event, the system calls one or more OS classification extensions to computationally determine the relative operational status of network elements based on the combinations of different metric values collected for each of the network elements.

Example Illustrations

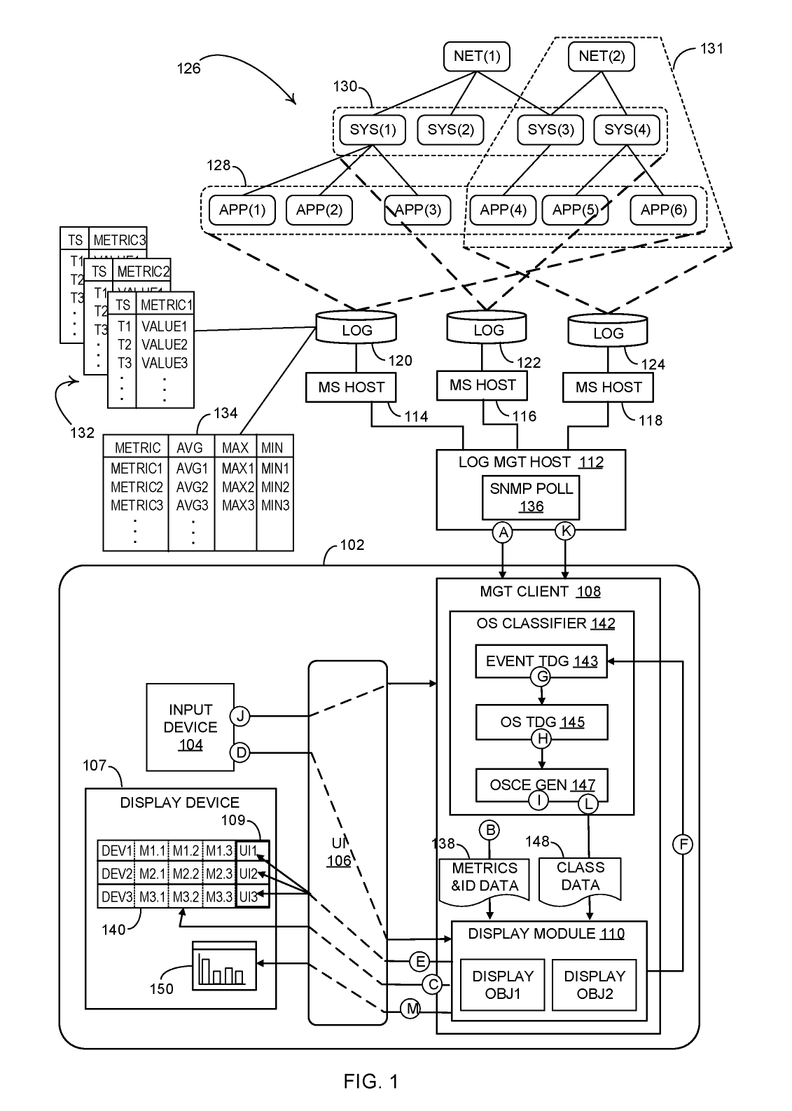

FIG. 1 is a block diagram depicting subsystems, devices, and other hardware and software components within a system for determining and displaying network element operational status in accordance with some embodiments. The system includes monitoring system hosts 114, 116, and 118 communicatively coupled to a client node 102. Client node 102 comprises a combination of hardware, firmware, and software configured to implement system management data transactions in cooperation with one or more of the monitoring system hosts. While not expressly depicted, each of the monitoring system hosts may include, in part, a host server that is communicatively connected to a management client application 108 within client node 102.

Each of monitoring system hosts 114, 116, and 118 may include a collection engine for collecting operational information such as performance metric data from network elements such a servers and processors within a network system, and recording the data in operational metrics (OM) logs 120, 122, and 124, respectively. Within the logs, the metric data may be stored in one or more relational tables that may comprise multiple series of timestamp-value pairs. For instance, OM log 120 includes multiple files 132 each recording a series of timestamps T₁-T_{N} and corresponding metric values Value₁-Value_{N} collected for one or more of the network elements. OM log 120 further includes a file 134 containing metric values computed from the raw data collected in association with individual timestamps. As shown, file 134 includes multiple records that associate a specified metric with computed average, max, and min values for the metrics specified within files 132. The performance metric data is collected and stored in association with network element profile data corresponding to the network elements from/for which the metric data is collected. The profile data may be stored in relational tables such as management information base tables (not depicted).

Each of monitoring system hosts 114, 116, and 118 and corresponding monitoring agents (not depicted) are included in a respective service domain for a target system that may comprise a network system including one or more networks each containing operationally associated elements. In FIG. 1, the system is depicted as a tree structure 126 comprising multiple hierarchically configured or otherwise interconnected nodes. As shown, the target system represented by tree structure 126 comprises two networks, NET(1) and NET(2), with NET(1) including three subsystems, SYS(1), SYS(2), and SYS(3), and NET(2) including SYS(3) and SYS(4). The subsystems may comprise application server systems that host one or more of applications APP(1) through APP(6). As further shown, some of the network elements represented within tree structure 126 are included in one or more of three service domains 128, 130, and 131. For instance, all of the applications APP(1) through APP(6) are included in service domain 128, all subsystems SYS(1) through SYS(4) are included in service domain 130, and all hierarchically related components of NET(2) are included in service domain 131.

The depicted system further includes a log management host 112 that includes components for correlating performance metric data from the services domains 128, 130, and 131 to generate operational information for the network elements that can be processed by components within management client 108. In the depicted embodiment, log management host 112 includes a SNMP poll unit 136 that initiates polling operations to collect operational metrics from monitoring system hosts 114, 116, and 118.

Client node 102 includes a user input device 104 such as a keyboard and/or display-centric input device such as a screen pointer device. A user can use input device 104 to enter commands (e.g., select displayed object) or data that are processed via a UI layer 106 and received by the system and/or application software executing within the processor-memory architecture (not expressly depicted) of client node 102.

User input signals from input device 104 may be translated as keyboard or pointer commands directed to management client 108. Management client 108 includes a display module 110 that is configured to generate graphical objects, such as a metric object 140. Graphical representations of metric object 140 are rendered via UI layer 106 on a display device 107, such as a computer display monitor.

The following description is annotated with a series of letters A-M. These letters represent stages of operations for determining network element relative operational status. Although these stages are ordered for this example, the stages illustrate one example to aid in understanding this disclosure and should not be used to limit the claims. Subject matter falling within the scope of the claims can vary with respect to the order and type of the operations.

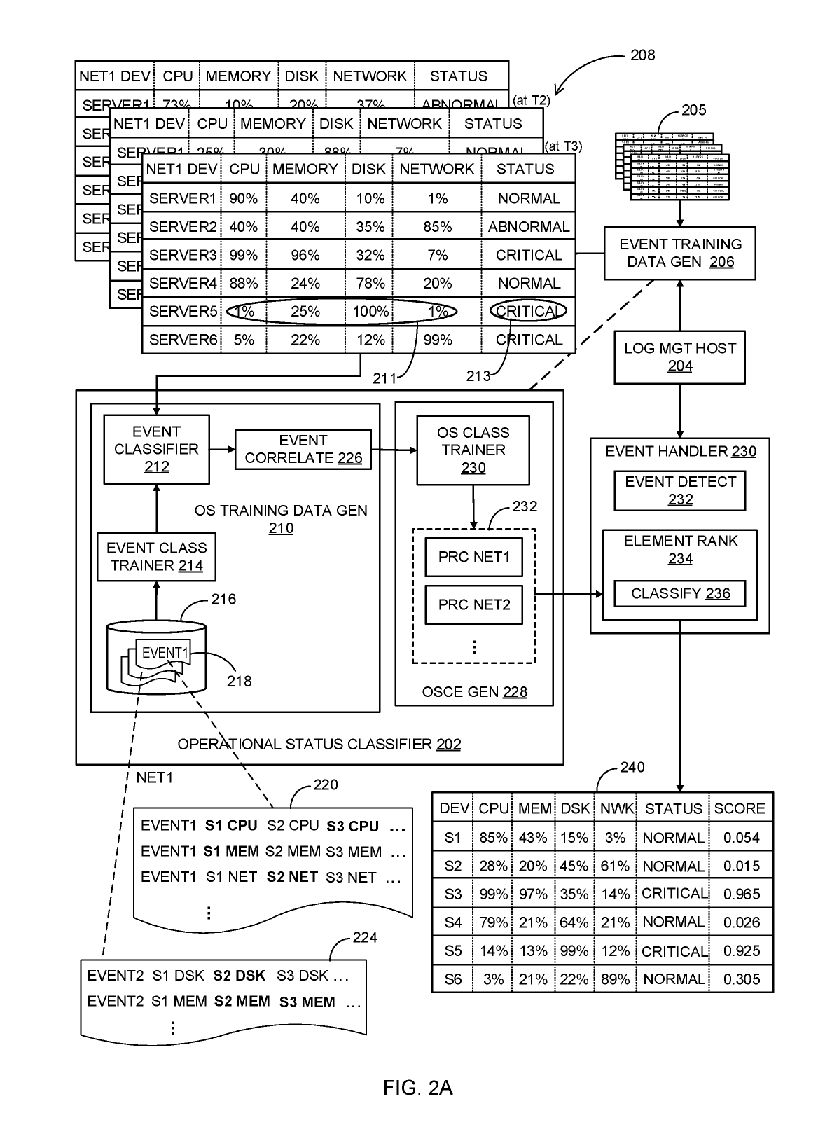

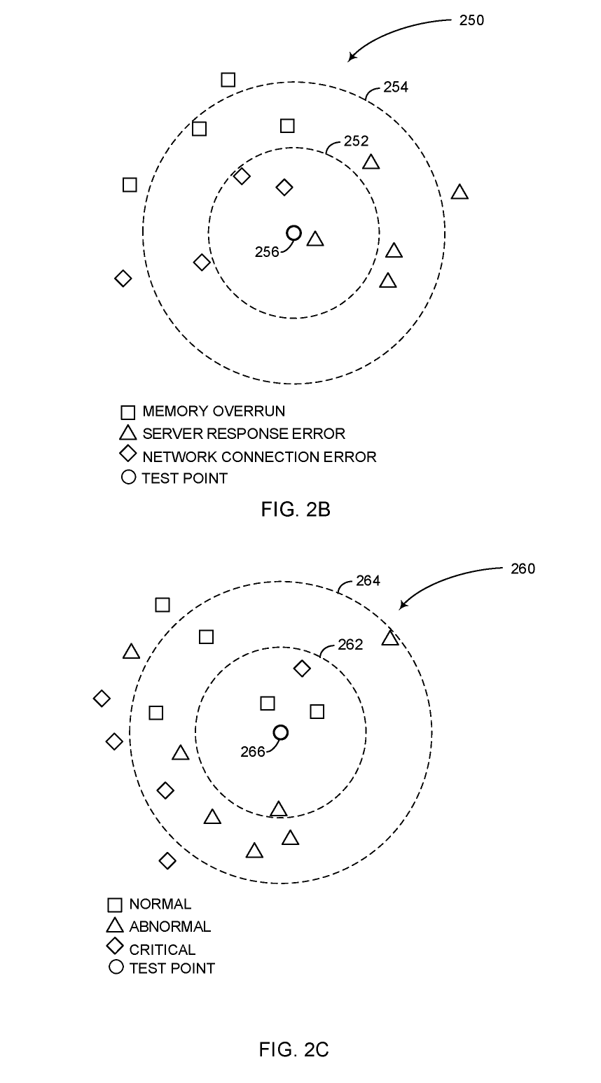

At stage A, log management host 112 transmits operational metric values collected by SNMP poll unit 136 to management client 108. The operational metrics values (operational metrics) may be transmitted by log management host 112 periodically or in response to a request from management client 108. As depicted and described in further detail with reference to FIG. 2A, the operation metrics received by management client 108 comprise data structures such as files and records. In some embodiments, the operational metrics are recorded in corresponding metric value fields within operational instance records that each further include an associated network element ID. At stage B, management client 108 formats the operational metric data received from log management host 112 and sends the combined metrics and network element ID information to display module 110. The metrics and ID information is converted by display module 110 into a display object, DISPLAY OBJ1, which is rendered via UI layer 106 at stage C as metric object 140 on display device 107.

Metric object 140 is a displayed representation of operation status for each of multiple network elements at a same instance in the operation of the network elements. Metric object 140 is configured in a tabular format having multiple row-wise records that each correspond to a respective network element. Each of the network element records comprises a combination of different metric value fields that is associated with a respective network element ID field. For example, the second row-wise network element records comprises a combination of three metric value fields containing metric values, M2.1, M2.2, and M2.3. The combination of metric values are associated with a network element ID, DEV2.

Metric object 140 is a user interface (UI) object that includes UI input objects 109 within or otherwise logically associated with each of the network element records. In this manner, metric object 140 includes the fixedly displayed metric and element ID information in the records in association with respective ones of the three UI input objects 109, which for example may be text input objects and/or menu selection objects. UI input objects 109 provide a means to receive UI input selections such as via input device 104 to select, at stage D, an OS classification for each of the three network element records within metric object 140. For instance, at stage E, display module 110 may receive menu selections of one of the OS classifications, NORMAL, ABNORMAL, and CRITICAL, entered/selected for each of UI input objects 109. Continuing with stage E, display module 110 displays the selected OS classification inputs within metric object 140.

At stage F, which may or may not coincide with stage E, display module 110 forwards network element records represented by metric object 140 to an event training data generator 143 within OS classifier 142. Each of the network element records includes the metric information, the element ID, and the corresponding OS classification. In some embodiments, the network element records are combined within a single network operational instance record. Event training data generator 143 is configured to process, at stage G, the operational instance record, including any necessary re-formatting, to conform to a pattern recognition or matching classification process implemented by an OS training data generator 145. For example, OS training data generator 145 may include event classification components configured to determine a network event classification for each of the operational instance records received by event training data generator from display module 110. In this case, event training data generator 143 includes program components configured to select event pattern recognition operational metric categories that are utilized by the event pattern recognition process, and de-select operational metric categories included in the operational instance records received by event training data generator but not utilized by the event matching process. For example, the operational instance records received by event training data generator 143 may include processor utilization, memory utilization, and network interface utilization, and the pattern recognition process may utilize processor and network interface utilization but not memory utilization. In this case, event training data generator 143 selects processor and network utilization and excludes memory utilization from corresponding operational instance records to be provided to OS training data generator 145 at stage G.

At stage H, OS training data generator 145 processes operational instance records received from event training data generator 143 to generate operational instance records that are each classified as associated with a particular network event. As depicted and described in further detail with reference to FIG. 2A, OS training data generator 145 may include supervised pattern recognition classification components that process the records as labelled training data sets. To this end, OS training data generator 145 includes an event classifier component (not expressly depicted in FIG. 1) that is generated by an event classification trainer component (also not expressly depicted). The event classifier component is configured to implement a supervised pattern recognition algorithm such as a k-nearest neighbor (k-NN) classification algorithm to classify each of the operational instance records as corresponding to a respective network event. The classified operational instance records may then be used as training data that is labelled by the event type as well as operational metric categories (e.g., network utilization) and input or otherwise provided by OS training data generator 145 to an operational status classification extension (OSCE) generator 147.

At stage I, OSCE generator 147 processes the training data sets in the form of the event-labelled operational instance records generated by OS training data generator 145 to generate OS classification extensions that include patterns recognition code. As depicted and described in further detail with reference to FIG. 2A, OSCE generator 147 includes a training component configured to execute a supervised learning function on the labelled training data from OS training data generator 145. The trainer component processes each of the event-labelled operational instance records to generate OS pattern recognition code for a given set of the training records. Continuing with stage I, OSCE generator 147 stores the OS classification extension including the pattern recognition code to be executed during runtime network monitoring operations to classify the operational status of network elements based on runtime operational status metrics.

At stage J, a operational metric collection request is input to UI input device 104 and transferred via UI layer 106 to management client 108. For example, the collection request may specify a network element polling operation. In response, at stage K, log management host 112 collects operational metric values from network elements and transmits or otherwise provides access to the metrics by management client 108. The operational metric values received from log management host 112 are processed by management client 108 to generate an operational instance record structured similarly to the records generated as described with reference to stage B. In this manner the operational instance record comprises multiple network element records. Each network element record includes a network element ID associated with a combination of operational metric values.

At stage L, OSCE generator 147 is accessed such as by an event handler program component (not depicted in FIG. 1) within management client 108 to call a selected one or more OS classification extensions. At stage L, the selected OS classification extension (e.g., a plugin) is executed to process the operational instance record by executing the stored OS pattern recognition code to determine OS classifications for each of the network elements corresponding to the network element IDs for each of the network element records. Continuing with stage L, OSCE generator 147 provides the resultant OS classification data to display module 110. At stage M, display module 110 generates a display object, DISPLAY OBJ2, based on the OS classification data and displays the object as an operational status classification object 150 within display device 107.

FIG. 2A is block diagram illustrating subsystems, devices, and other hardware and software components within a system for collecting and processing network element operational metric information to configure and execute an operational status classification extension in accordance with some embodiments. The system depicted in FIG. 2A may be implemented by corresponding devices and components depicted and described with reference to FIG. 1. The system includes an OS classifier component 202 that is configured using any combination of program logic and data to determine operational status classifications (e.g., NORMAL, ABNORMAL, CRITICAL) for operationally associated network elements.

OS classifier 202 includes programmed components for implementing a form of machine learning to generate OS classification components configured to classify each of multiple network elements based on a combination of multiple different operational metrics. OS classifier 202 includes components for processing OS classification UI inputs as training data and also components for pre-conditioning the UI sourced training data using event classification data. Namely, OS classifier 202 includes an event training data generator 206 that, as illustrated in FIG. 1, receives as input UI sourced OS classification records 205 such as may be generated by a management client as described with reference to FIG. 1.

Event training data generator 206 compares the operational metric categories of the operational metrics included in operational instance records 205 with operational metric categories utilized by an event classifier 212. For example, an operational instance record received by event training data generator 206 may include network element records that each include processor utilization, memory utilization, and network utilization metric values. Event classifier 212 may utilize processor and memory utilization metrics and does not use network utilization metrics. In this case, event training data generator 206 generates operational instance records comprising network element records that each include processor and memory utilization metric values and that do not include network utilization metric values.

In the depicted embodiment, event training data generator 206 generates labelled training data sets in the form of a series of operational instance records 208. Each of operational instance records 208 comprises a set of network element records that each include an element ID field associated with a combination of operational metric fields and an OS classifier field. In some embodiments, the operational metric values within each of operational instance records 208 have been collected at a given operational instance within a time period coinciding event sequence such as a series of points in time series coinciding with a detected network event. As a labelled training data set, each network element records in each of operational instance records 208 includes an input vector, such as input vector 211, comprising a combination of multiple operational metric values. Each of the network elements further includes a supervisor value, such as supervisor value 213, comprising an OS classification.

Operational instance records 208 are input to event classifier 212 which is configured using any combination of program code to determine an event classification for each operational instance record. In some embodiments, event classifier 212 includes program code for implementing a supervised pattern recognition algorithm such as a k-NN algorithm. A k-NN algorithm is a process that classifies data objects/points based on a number of closest training values that are mapped into a multi-dimensional feature space. The feature space is partitioned into regions in accordance with classification labels of the training values. In the depicted embodiment, the classification algorithm is an inferential pattern-matching function that applies a multi-dimensional feature space that is computationally generated by an event classification trainer component 214 based on event patterns 218 stored within an event pattern repository 216.

In some embodiments, event patterns 218 are stored records of operational metrics (e.g., processor utilization) for network elements that are stored in association with one of multiple network event types (e.g., server response error). Two example network event patterns, 220 and 224, are depicted as including an event ID associated with combinations of network element ID/operational metric pairs. Event pattern 220 includes multiple records that each associate a same event, EVENT1, with multiple element ID/operational metric values. For instance, the second row-wise record of event pattern 220 includes an event ID, EVENT1, associated with a server ID/CPU utilization metric pair, conceptually rather than numerically represented as CPU. The same record associates EVENT1 with other server ID/CPU utilization metric pairs including S2/CPU and S3/CPU. Similarly, the first row-wise record of event pattern 224 includes an event ID, EVENT1, associated with a server ID/disk utilization metric pair, conceptually rather than numerically represented as DSK in addition to other server ID/disk utilization pairs.

Event classification trainer 214 generates the event classifier code that implements inferential pattern recognition by processing event records 218 for multiple different events. When executed, event classifier 212 generates a multidimensional feature space that was determined by event classification trainer 214 during the training phase and stored in association with pattern recognition code within event classifier 212. A conceptual representation of an example k-NN map feature space is illustrated in FIG. 2B. As shown in FIG. 2B, the feature space 250 is populated with multiple training value points each having a respective assigned event classification. The depicted squares are points in the feature space each classified by event classification trainer 214 as a memory overrun, the depicted triangles are points each classified as a server response error, and the depicted diamonds each are classified as a network connection error.

To implement k-NN pattern classification, event classifier 212 determines a position of an input point 256 within feature space 252. Input point 256 represents the combination of operational metrics contained within a given input operational instance record received by event classifier 212 from event training data generator 206. For k-NN pattern classification, the relative spacing between and among the training points and input point 256 may be computed as Euclidean distances. In this manner, event classifier 212 computes a relative positioning of input point 256 among the training points which includes, at least in part, determining a Euclidean distance between the metric data represented by input point 256 and the metric data represented by each of the training points.

To further implement k-NN pattern classification, event classifier 212 partitions the feature space 250 into which the training points are mapped with respect to both the position of input point 256 and an input integer value for k. The partitions are represented in FIG. 2B as circular/radial boundaries centered at input point 256 and having a radius determined by a number of nearest neighbors (specified by k) used for classification. As shown, event classifier 212 determines a radial distance partition 252 for a value of k=3 in which the closest three “neighbor” training points are included. If event classifier 212 executes the pattern classification algorithm with a value of k=9, the radial distance is determined to be radial distance partition 254. For k=3, event classifier 212 classifies input point 256 as being or corresponding to a network connection error since a majority (two of the three) training points within partition 252 are classified as network connection errors. Similarly, for k=9, event classifier 212 classifies input point 256 as being or corresponding to a network connection error based on determining that a largest plurality (four of nine) training points within partition 254 are classified as server response errors.

Having classified the one or more operational instance records as one or more particular event types, event classifier 212 records the classification such as by including classification ID entries in each of multiple operational instance records each corresponding to and including the content of a respective one of operational instance records 208. The event classified operation instance records are processed by an event correlator component 226 that is configured to correlate same-event operational instance records. For example, event correlator 226 determines which operational instance records have a same event classification (e.g., classified as memory overrun) and record a corresponding association among all such records.

The sets of event-correlated operational instance records are processed by an OS classification extension (OSCE) generator 228 to generate OS classification extensions that implement a second level of classification. The operational instance records are processed by an OS classification trainer component 230 to generate one of a set of pattern recognition code (PRC) components 232 that each comprise program code for implementing a supervised pattern recognition algorithm such as a k-NN algorithm. In some embodiments, OS classification trainer 230 is configured to generate a k-NN feature space of training points corresponding to the metric data in each of the network element records within the operational instance records.

FIG. 2C depicts a conceptual representation of a k-NN map generated by OS classification trainer 230 and OS classifier components within OSCE generator 228 in accordance with some embodiments. OS classification trainer 230 receives the event-correlated operational instance records as supervised training data sets from OS training data generator 210. In some embodiments, the event-correlated operational instance records are configured substantially the same as operational instance records 208 and further include an inserted event classifier ID for each record. OS classification trainer 230 generates the OS classifier code that implements inferential pattern recognition by processing the training data sets in the form of the event-correlated operational instance records.

As shown in FIG. 2C, the k-NN map includes a feature space 260 that is populated with multiple training value points each having an assigned or otherwise logically associated operational status classification. The depicted squares are points in the feature space each classified by OS classification trainer 130 as NORMAL, the depicted triangles are points each classified as ABNORMAL, and the depicted diamonds are points each classified as CRITICAL. OS classification trainer 130 encodes the feature space within one of the depicted event classification extensions in the form of PRC components 232.

PRC components 232 are recorded and maintained by OSCE generator 228 in a manner accessible such as by program call to an event handler 230. Event handler 230 may be a component included in a management client such as management client 108 in FIG. 1. Event handler 230 includes an event detector component 232 that is configured to detect the occurrence of a network operational event such as a server response error based on operational metrics received from a log management host 204. In some embodiments, event detector 232 is configured using any combination of program logic to detect events by calling event classifier 212 to process one or more operational instance records that include the operational metrics.

Event handler 230 further includes an element rank component 234 that is configured to determine operational status classifications of individual network elements based on real-time operational instance records. Element rank component 234 includes a classifier component 236 that is configured to call and execute one or more of the pattern recognition code components, such as PRC NET1 and/or PRC NET2 in response to a UI input request and/or an event detected by event detector 232. In response to event detector 232 detecting a network event during run-time operational monitoring of elements within a network, element rank component 234 reads network ID information and event ID information associated with the detected event to select one or more of the pattern recognition code components within OS classification extensions 232.

Element rank component 234 calls the PRC component to be executed as part of classifier component 236 to determine the OS classification of individual network elements. Having called the PRC component, including retrieving the training data set forming the feature space 260, classifier component 236 determines, based on the selected PRC component, which operational metrics are utilized by the PRC component to determine relative distances among the training points within feature space 260. For example, the PRC component may utilize a combination of CPU utilization, memory utilization, disk utilization, and network utilization metrics. In response to determining the combination operational metrics, used to form feature space 260, classifier 236 retrieves the corresponding operational metric values for each of the network elements from event detector 232 and/or log management host 204. The retrieved operational metric values are collected at one or more time instance coinciding with the occurrence of the detected event.

In some embodiments, the operational metrics may be received by classifier 236 in the form of an operational instance record formatted similarly to operational instance records 208 excluding the OS status classifiers. Once the operational metrics for each of the network elements are collected, such as via an operational instance record, classifier 236 executes OS classification code in the form of the k-NN PRC code to determine the operational status classification of each of the network elements identified in each of the network element records by generating a k-NN map such as depicted in FIG. 2C for each of the network element records. Each of the network element records within the operational instance record includes an element ID associated with the determined combination of operational metric values. A network element record is input to classifier 236 which is configured using any combination of program code including the PRC code to determine an OS classification for the network element record. In some embodiments, classifier 236 includes program code for implementing a supervised pattern classification algorithm such as a k-NN algorithm. In the depicted embodiment, the classification algorithm is an inferential pattern-matching function that applies the multi-dimensional feature space that is computationally generated by an OS classification trainer 230.

When executed, classifier 236 generates a multidimensional feature space that was determined by OS classification trainer 230 during the training phase and stored in association with pattern recognition code within one of the PRC components. To implement k-NN pattern classification, classifier 236 determines a position of an input point 266 within feature space 252. Input point 256 represents the combination of operational metrics contained within a given input network element record within the received operational instance record. For k-NN pattern classification, the relative spacing between and among the training points and input point 266 may be computed as Euclidean distances. In this manner, classifier 236 computes a relative positioning of input point 266 among the training points which includes, at least in part, determining a Euclidean distance between the metric data represented by input point 266 and the metric data represented by each of the training points.

To further implement k-NN pattern classification, classifier 236 partitions the feature space 260 into which the training points are mapped with respect to both the position of input point 266 and an input integer value for k. The partitions are represented in FIG. 2C as circular/radial boundaries centered at input point 266 and having a radius determined by a number of nearest neighbors (specified by k) used for classification. As shown, classifier 236 determines a radial distance partition 262 for a value of k=4 in which the closest four “neighbor” training points are included. If classifier 236 executes the pattern classification algorithm with a value of k=11, the radial distance is determined to be radial distance partition 264. For k=4, classifier 236 classifies input point 266 as being or corresponding to NORMAL since a largest plurality (two of the four) of the training points within partition 262 are classified as NORMAL. For k=11, classifier 236 classifies input point 266 as being or corresponding to ABNORMAL based on determining that a majority (six of eleven) training points within partition 264 are classified as ABNORMAL.

Having classified the each of the network element records as one or more particular event types, element rank component 234 records the classifications within an operational instance record 240. For instance, the third row-wise network element record within operational instance record 240 includes an element ID, S3, associated with a corresponding combination of operational metric values and an OS classification ID, CRITICAL.

In some embodiments, classifier 236 is configured to determine an additional, relative OS classification in the form of a quantified operational classification that can be used to determine a relative operational status ranking among the network elements. Classifier 236 applies the same training data set and for regression assigns a numeric weight to each of the training points, such as the training points depicted in FIG. 2C. For example, each of the training points may be assigned a weight of 1/d, in which d is the distance from an input point, such as input point 266 to a given training point. In this manner, classifier 236 computes relative numeric operational status values, such as percentage values or the equivalent that indicates the level of criticality of each of the network components. The quantified classification values are entered as numeric score values within each of the network element records within operational instance record 240.

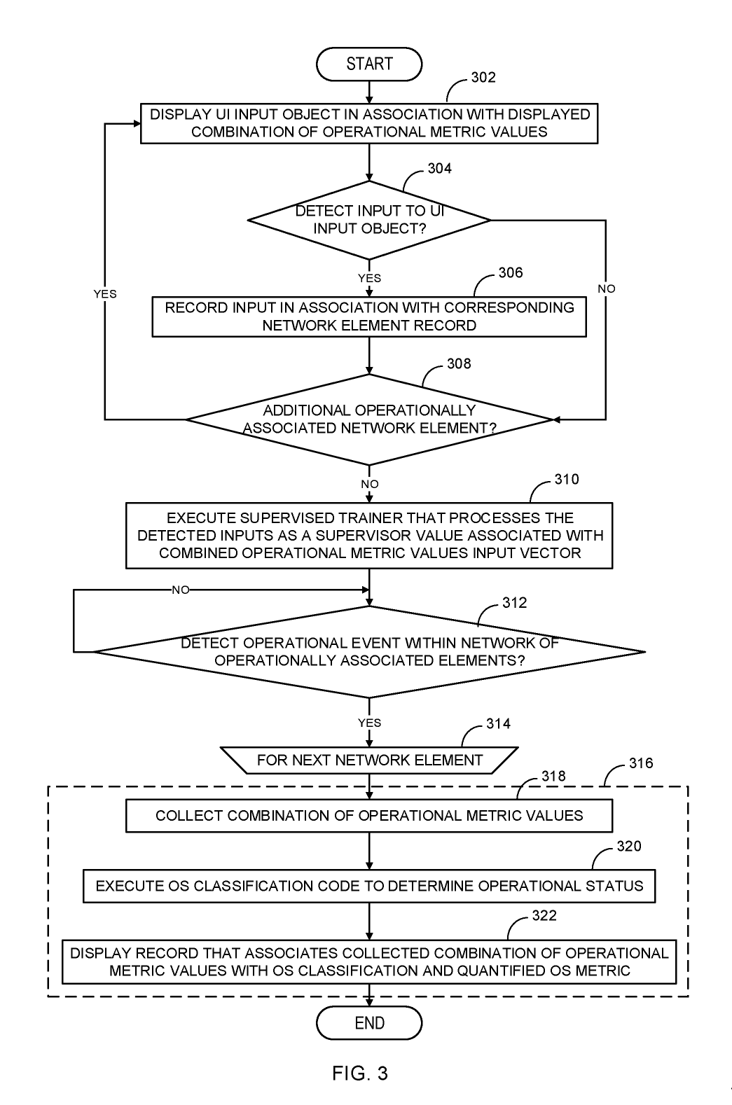

FIG. 3 is a flow diagram illustrating operations and functions for determining and displaying network element operational status in accordance with some embodiments. The operations and functions depicted and described with reference to FIG. 3 may be performed by one or more of the systems, devices, and components illustrated and described with reference to FIGS. 1 and 2. The process begins as shown at block 302 with a management client, such as management client 108 in FIG. 1, displaying a UI input object in association with a displayed combination of operational metric values. For example, the UI input object may be a text input object or a menu select object that is displayably included within a displayed network element record that includes multiple fields displaying each of the combination of operational metric values.

In response to detecting an input to the UI input object at block 304, the management client records the input in association with the corresponding network element record (block 306). For example, the UI input may be an operational status classification specifier that is either entered or otherwise selected and recorded in association with the corresponding network element record. Next, or if no UI input is detected at block 304 for the network element record, control passes to block 308 a determination of whether additional UI input objects remain. If so, control returns to blocks 302 and 304 with the management client displaying and detecting for another network element record whether an input is received to the corresponding UI input object.

Once UI inputs have been detected and recorded for all network element records within an operational instance record, the process continues at block 310 with an OS classifier executing a supervised trainer component that processes each of the detected and recorded inputs as a supervisor value associated with combined operational metric values that serve as an input vector. At block 312, the management client detects an operational event within the network of operationally associated network elements. In response to detecting the network event, and for each of the operationally associated elements beginning at block 314, management client components including the OS classifier determines and displays the operational status of each of the network elements (superblock 316). The operational status determination begins as shown at block 318 with a OS classifier collecting from the management client combinations of operational metric values for each of the set of operationally associated network elements. The OS classifier calls and executes the OS classification code generated at block 308 using element-specific sets of the operation metric combinations to determine OS classifications for each of the network elements (block 320). At block 322, the management client displays records (one for each network element) that associate the respective combinations of operational metrics with an unweighted label classifier and a quantified classifier, such as a numeric percentage value.

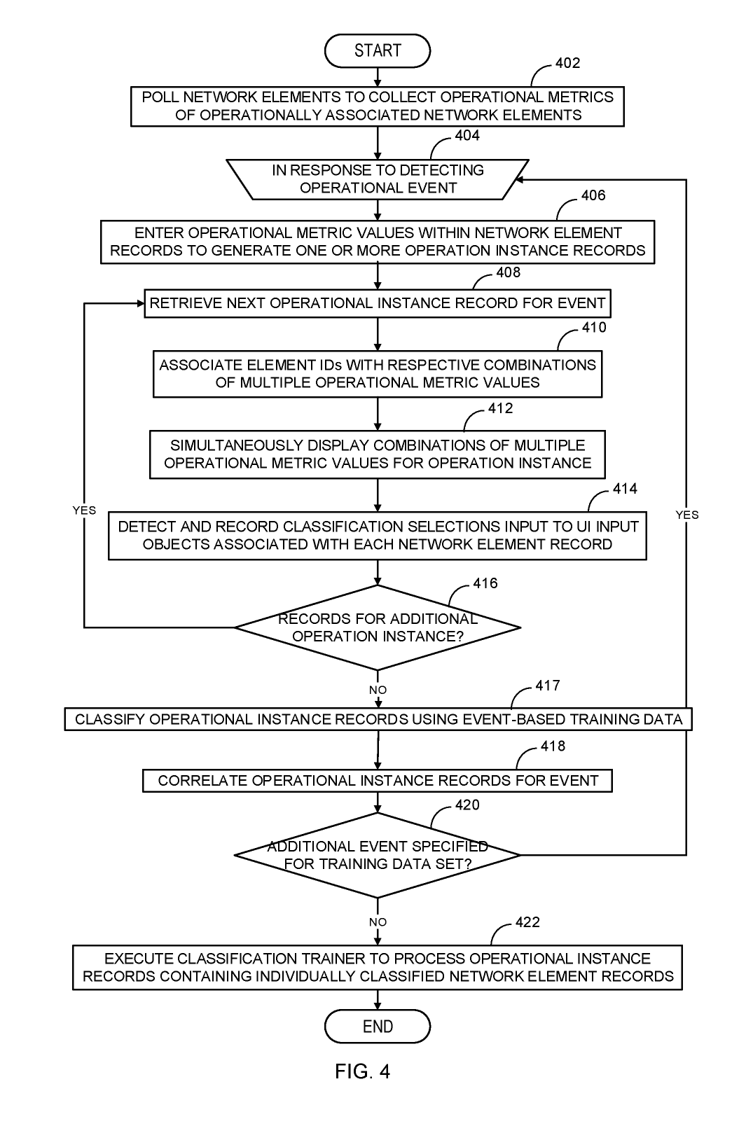

FIG. 4 is a flow diagram depicting operations and functions for processing network element operational information to generate a status classification extension in accordance with some embodiments. The operations and functions depicted and described with reference to FIG. 3 may be performed by one or more of the systems, devices, and components illustrated and described with reference to FIGS. 1 and 2. The process begins as shown at block 402 with log management host and management client components polling network elements to collect operational metrics for each of a set of operationally associated network elements. In response to the management client detecting an operational event at block 404, training data collection components within the management client perform a series of steps to generate a first stage of training data.

At block 406, the management client records operational metric values received from the log management host within network element records to generate operation instance records such as those depicted and described with reference to FIGS. 1 and 2. At block 408, the management client retrieves the next of the operational instance records generated at block 406. At block 410, the management client associates element IDs with the combination of operational metric values collected for/from the element identified by the element ID. At block 412, the management client simultaneously displays, such as within a UI object, the combinations of metric value for all of the network element records within the operational instance record. At block 414, the management client detects and records classification selections received at UI input objects within or otherwise associated with the displayed object containing the combinations of metric values.

If additional training data sets in the form of operational instance records remain as determined at block 416, control returns to block 408 to begin a processing sequence for the next operational instance record. Otherwise, control passes to block 417 with an OS training data generator classifying each of the operational instance records using event-based training data. At block 418, the OS training data generator correlates the event-classified operational instance records by respective event types. An OS training data generator determines, at block 420, whether additional training data corresponding to, for example, different event types is required. If so, control returns to block 404. If not, at block 422 an OS classification trainer is executed using the event correlated and classified records to generate pattern recognition code and corresponding feature spaces for determining OS classifications for network element records.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java° programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

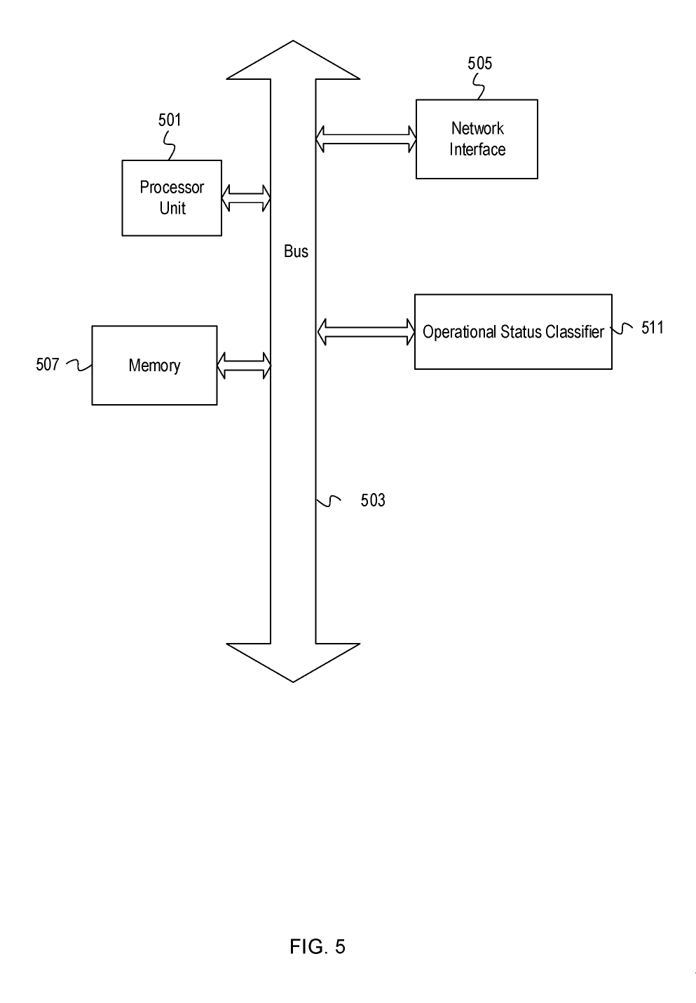

FIG. 5 depicts an example computer system for determining network element operational status in accordance with some embodiments. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand° bus, NuBus, etc.) and a network interface 505 (e.g., a Fiber Channel interface, an Ethernet interface, an internet small computer system interface, SONET interface, wireless interface, etc.). The system also includes a management client 511 such as may incorporate the systems, devices, and components depicted and described with reference to FIGS. 1-4. The management client 511 provides program structures for generated multiple stage of training data to generate OS classification extensions as depicted and described with reference to FIGS. 1-4. To this end, the management client 511 may incorporate and/or utilize some or all of the system, devices, components, and data structures described in FIGS. 1-4.

Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for implementing data collection workflow extensions as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method for determining network element operational status, said method comprising:
for each of a first plurality of operationally associated network elements,
displaying a combination of operational metric values each corresponding to one of a plurality of metric types;
displaying a user interface (UI) input object in association with the displayed combination of operational metric values; and
detecting an input to the UI input object;
generating operational status classification code by executing a classification trainer that processes each of the detected inputs as an operational status classification associated with the corresponding combination of operational metric values; and
in response to detecting an operational event within a network that includes a second plurality of operationally associated network elements,
determining an operational status for each of the second plurality of operationally associated network elements, including,
collecting a combination of operational metric values, each corresponding to one of the plurality of metric types; and
executing the operational status classification code to determine an operational status of at least one of the second plurality of network elements based on the collected combination of operational metric values for the at least one of the second plurality of network elements and the collected combination of operational metric values for at least one other of the second plurality of network elements.

2. The method of claim 1, wherein said generating operational status classification code comprises generating pattern recognition code by executing a supervised trainer that processes each of the detected inputs as a supervisor value that is associated with a corresponding input vector comprising the corresponding combination of operational metric values.

3. The method of claim 1, wherein the determined operational status comprises an operational status classification and a quantified operational status metric, said method further comprising, for each of the at least one of the second plurality of network elements, displaying a record that associates the collected combination of operational metric values with the operational status classification and the quantified operational status metric.

4. The method of claim 1, wherein said executing the operational status classification code includes applying a distance function to determine a distance between the collected combination of operational metric values and at least two training values generated by the classification trainer.

5. The method of claim 1, further comprising collecting the combination of operational metric values for each of the second plurality of network elements at each of a plurality of network operation instances.

6. The method of claim 5, wherein said displaying a combination of operational metric values, said displaying a UI input object, and said detecting an input to the UI input object are performed for each of the combinations of operational metric values collected at each of the network operation instances.

7. The method of claim 6, wherein said detecting an input to the UI input object comprises detecting a selected one of a plurality of operational status classifications, said method further comprising associating the selected operational status classification with the displayed combination of operational metric values.

8. The method of claim 7, further comprising, for at least two of the combinations of operational metric values collected at each of the network operation instances, associating each of the selected operational status classifications with each of the other selected operational status classifications.

9. One or more non-transitory machine-readable media comprising program code for determining network element operational status, the program code to:
for each of a first plurality of operationally associated network elements,
display a combination of operational metric values each corresponding to one of a plurality of metric types;
display a user interface (UI) input object in association with the displayed combination of operational metric values; and
detect an input to the UI input object;
generate operational status classification code by executing a classification trainer that processes each of the detected inputs as an operational status classification associated with the corresponding combination of operational metric values; and
in response to detecting an operational event within a network that includes a second plurality of operationally associated network elements,
determine an operational status for each of the second plurality of operationally associated network elements, including,
collecting a combination of operational metric values, each corresponding to one of the plurality of metric types; and
executing the operational status classification code to determine an operational status of at least one of the second plurality of network elements based on the collected combination of operational metric values for the at least one of the second plurality of network elements and the collected combination of operational metric values for at least one other of the second plurality of network elements.

10. The machine-readable media of claim 9, wherein the program code to generate operational status classification code comprises program code to generate pattern recognition code by executing a supervised trainer that processes each of the detected inputs as a supervisor value that is associated with a corresponding input vector comprising the corresponding combination of operational metric values.

11. The machine-readable media of claim 9, wherein the program code to execute the operational status classification code includes program code to apply a distance function to determine a distance between the collected combination of operational metric values and at least two training values generated by the classification trainer.

12. The machine-readable media of claim 9, further comprising program code to collect the combination of operational metric values for each of the second plurality of network elements at each of a plurality of network operation instances.

13. The machine-readable media of claim 12, wherein said displaying a combination of operational metric values, said displaying a UI input object, and said detecting an input to the UI input object are performed for each of the combinations of operational metric values collected at each of the network operation instances.

14. The machine-readable media of claim 13, wherein the program code to detect an input to the UI input object comprises program code to detect a selected one of a plurality of operational status classifications, and wherein the program code further includes program code to associate the selected operational status classification with the displayed combination of operational metric values.

15. The machine-readable media of claim 14, further comprising program code to, for at least two of the combinations of operational metric values collected at each of the network operation instances, associate each of the selected operational status classifications with each of the other selected operational status classifications.

16. An apparatus comprising:
a processor; and
a machine-readable medium having program code executable by the processor to cause the apparatus to:
for each of a first plurality of operationally associated network elements,
display a combination of operational metric values each corresponding to one of a plurality of metric types;
display a user interface (UI) input object in association with the displayed combination of operational metric values; and
detect an input to the UI input object;
generate operational status classification code by executing a classification trainer that processes each of the detected inputs as an operational status classification associated with the corresponding combination of operational metric values; and
in response to detecting an operational event within a network that includes a second plurality of operationally associated network elements,
determine an operational status for each of the second plurality of operationally associated network elements, including,
collecting a combination of operational metric values, each corresponding to one of the plurality of metric types; and
executing the operational status classification code to determine an operational status of at least one of the second plurality of network elements based on the collected combination of operational metric values for the at least one of the second plurality of network elements and the collected combination of operational metric values for at least one other of the second plurality of network elements.

17. The apparatus of claim 16, wherein the program code to generate operational status classification code comprises program code to generate pattern recognition code by executing a supervised trainer that processes each of the detected inputs as a supervisor value that is associated with a corresponding input vector comprising the corresponding combination of operational metric values.

18. The apparatus of claim 16, wherein the program code to execute the operational status classification code includes program code to apply a distance function to determine a distance between the collected combination of operational metric values and at least two training values generated by the classification trainer.

19. The apparatus of claim 16, further comprising program code to collect the combination of operational metric values for each of the second plurality of network elements at each of a plurality of network operation instances wherein said displaying a combination of operational metric values, said displaying a UI input object, and said detecting an input to the UI input object are performed for each of the combinations of operational metric values collected at each of the network operation instances.

20. The apparatus of claim 19, wherein the program code to detect an input to the UI input object comprises program code to detect a selected one of a plurality of operational status classifications, and wherein the program code further includes program code to:
associate the selected operational status classification with the displayed combination of operational metric values; and
for at least two of the combinations of operational metric values collected at each of the network operation instances, associate each of the selected operational status classifications with each of the other selected operational status classifications.
